(19) United States
(12) Patent Application Publication
(10) Pub. No.: US 2018/0194514 A1
(43) Pub. Date: Jul. 12, 2018

(54) TRANSFER TRAY AND TRANSPORT ROBOT COMPRISING THE SAME

(71) Applicant: BOE TECHNOLOGY GROUP CO., LTD., Beijing (CN)

(72) Inventors: Ying ZHANG, Beijing (CN); Yifei ZHANG, Beijing (CN); Kai ZHAO, Beijing (CN); Yu GU, Beijing (CN); Hongli DING, Beijing (CN)

(21) Appl. No.: 15/527,815

(22) PCT Filed: Sep. 19, 2016
(86) PCT No.: PCT/CN2016/099330

§ 371 Date: May 18, 2017

(30) Foreign Application Priority Data
Apr. 15, 2016 (CN) 201610236045.8

(51) Int. Cl. B65D 19/38; B25J 11/00; B65D 19/00

(52) U.S. Cl. CPC B65D 19/38; B25J 11/008; B65D 2519/00776; B65D 19/0012; B65D 2519/00273; B65D 19/0002

(57) ABSTRACT

The A transfer tray includes a fixed tray; a movable tray which can move relative to the fixed tray; several anti-shake actuators disposed on the fixed tray; a shake detection device disposed on the movable tray or the fixed tray; and a control device. The shake detection device is configured to detect the shake information of the movable tray or the fixed tray. The control device is configured to control several anti-shake actuators to drive the movable tray to move in a direction opposite to the shaking direction based on the shake information of the movable tray or the fixed tray.

### RELATED APPLICATIONS

The present application is the U.S. national phase entry of PCT/CN2016/099330, with an international filing date of Sep. 19, 2016, which claims the benefit of a Chinese Patent Application No. 201610236045.8, filed on Apr. 15, 2016, the entire disclosure of which is incorporated herein by reference.

### FIELD OF THE DISCLOSURE

The present application relates to the technical field of a robot, and in particular to a transfer tray and a transport robot comprising the transfer tray.

### BACKGROUND OF THE DISCLOSURE

Recently, Hi-tech products such as robots have gradually swept into people's life. A robot is a machine which is programmed to move and perform certain tasks automatically. It is a product that highly integrates cybernetics, mechanical-electronic engineering, computer science, materials science and bionics. It can be commanded by a human or run predefined programs and behaviors according to certain rules formulated by artificial intelligence technology. Robots can assist or replace humans to perform some tasks such as production line operation, construction work or some high risk work, thereby playing an important role in the fields of industry, medicine, agriculture and military.

Currently, in the area of catering, food delivery robots have gradually appeared. Food delivery robots generally simulate humans, use two hands to hold a tray at its chest to deliver food, and have feet that are driven to walk by motorized wheels. In general, food delivery robots are equipped with dedicated tracks and can recognize and locate the tracks by photoelectric sensor(s) or camera(s). By using food delivery robots to deliver food, the number of the restaurant waiters can be reduced and the brand image of the restaurant can be promoted.

However, existing food delivery robots might shake due to all kinds of unexpected situations during delivering, causing food or liquid to spill out, which will greatly affect the safety of the food delivery of the robots.

### SUMMARY OF THE DISCLOSURE

The present disclosure provides a transfer tray and a transport robot comprising the transfer tray, which can reduce the shaking of the transfer tray of the transport robot so as to improve the safety of the objects transporting by the transport robot.

An embodiment of the present disclosure provides a transfer tray, comprising a fixed tray; a movable tray which can move relative to the fixed tray; several anti-shake actuators disposed on the fixed tray; a shake detection device disposed on the movable tray or the fixed tray; and a control device, wherein: the shake detection device is configured to detect the shake information of the movable tray or the fixed tray; the control device is configured to control several anti-shake actuators to drive the movable tray to move in a direction opposite to a shaking direction based on the shake information of the movable tray or the fixed tray.

In an embodiment of the present disclosure, when the transfer tray shakes, the anti-shake actuators can drive the movable tray to move in a direction opposite to the shaking direction, thereby to compensate the shake of the transfer tray. In this way, the transfer tray can be stabilized, and the food or liquid on the transfer tray can be avoided spilling out, so the safety of the object transporting is high.

In certain embodiments, the fixed tray has a containing space, wherein the movable tray can be disposed in the containing space of the fixed tray and can move horizontally relative to the fixed tray, and the several anti-shake actuators are be disposed between the side face of the movable tray and the inside wall of the fixed tray.

In certain embodiments, the movable tray is a rectangular movable tray, there are anti-shake actuators between the at least two adjacent side faces of the rectangular movable tray and the inside wall of the fixed tray respectively.

In certain embodiments, the bottom of the movable tray is provided with balls, or alternatively the inter bottom wall of the fixed tray is provided with balls. By means of such design, the friction of the movable tray relative to the fixed tray when moving can be reduced.

In an embodiment, the anti-shake actuator comprises a connecting post; a housing; and a fixing post, a first coil, a plurality of first permanent magnets and elastic member(s) disposed in the housing, wherein: the housing comprises a pedestal, a top lid and a yoke located between the pedestal and the top lid, wherein the top lid has a through hole which avoids the first coil and the fixing post, the connecting post is fixedly connected with the fixing post through the through hole of the top lid; the first coil is placed around the outside of the fixing post, the plurality of first permanent magnets are arranged to surround the first coil and the sides facing the first coil have the same magnetic property, the yoke is fixedly connected with the outside of the first permanent magnet, the elastic member connects the housing and the fixing post.

In certain embodiments, the elastic member is a planar spring, and the planar spring comprises an outer coil, an inner coil and a spring wire connecting the outer coil and the inner coil, wherein the inner coil is fixedly connected with the fixing post, and the outer coil is fixedly connected with the housing.

In a further embodiment, there are two planar springs, one of the planar springs is adjacent to the top lid and has an outer coil connected with the top lid, the other of the planar springs is adjacent to the pedestal and has an outer coil connected with the pedestal.

In a specific embodiment, the first coil is a coil in rectangular ring form, the number of the first permanent magnets is four, the four first permanent magnets are arranged to be adjacent to the four side faces of the first coil respectively.

In certain embodiments, the connecting post is fixedly connected with the movable tray. In this embodiment, the anti-shake actuators is fixedly connected with the movable tray by the connecting post, which not only can provide a pushing force for the movable tray in a direction opposite to the shaking direction, but also provide a pulling force for the movable tray in a direction opposite to the shaking direction, thereby greatly reducing the shake phenomenon of the transfer tray of the transport robot.

In certain embodiments, the fixing post is a magnetically conductive fixing post.

In another embodiment, the transfer tray further comprises a permanent magnet fixing element, the anti-shake actuator comprising a second coil, which is fixedly connected with the movable tray; a first permanent magnet set and a second permanent magnet set located at two ends of the second coil and spaced from the second coil, wherein the first permanent magnet set is fixedly connected with a permanent magnet fixing element, and the second permanent magnet set is fixedly connected with the fixed tray; a return spring, one end of which is connected with the fixed tray and the other end is connected with the movable tray.

In certain embodiments, the first permanent magnet set comprises a second permanent magnet and a third permanent magnet, and the second permanent magnet set comprise a fourth permanent magnet and a fifth permanent magnet located opposite to the second permanent magnet and the third permanent magnet respectively; wherein the magnetic properties of the second permanent magnet and the third permanent magnet at the sides facing the second coil are opposite, the magnetic properties of the fourth permanent magnet and the fifth permanent magnet at the sides facing the second coil are opposite, and the magnetic properties of the second permanent magnet and the fourth permanent magnet at the sides facing the second coil are opposite. In certain embodiments, the shake detection device comprises a gyroscope or an accelerometer.

Certain embodiment of the present disclosure also provides a transport robot comprising the transfer tray according to any one of the technical solutions. The transport robot has a good capability of preventing shaking and has high safety in transporting things.

### BRIEF DESCRIPTION OF THE DRAWINGS

The accompanying drawings are included to provide a further understanding of the embodiments and are incorporated in and constitute a part of this specification. The drawings illustrate the embodiments of the present disclosure and together with the description serve to explain the principles of the present disclosure. Other embodiments and many intended advantages of the embodiments will be easily appreciated by those skilled in the art, because those embodiments and advantages will be better understood by referring the following detailed descriptions. It should be noted that the figures are not necessarily drawn to scale and that elements of similar structures or functions are generally represented by like reference numerals for illustrative purposes throughout the figures.

FIG. 1 is a top view showing a transfer tray according to an embodiment of the present disclosure.

FIG. 2 is a sectional view showing a transfer tray according to a first embodiment of the present disclosure.

FIG. 3 is a structure schematic view of an anti-shake actuator according to the first embodiment of the present disclosure;

FIG. 4 is a sectional view of the anti-shake actuator according to the first embodiment of the present disclosure;

FIG. 5 is an exploded view of the anti-shake actuator according to the first embodiment of the present disclosure;

FIG. 6 is a top view of an elastic member according to the first embodiment of the present disclosure.

FIG. 7 is a top view of a transfer tray according to a second embodiment of the present disclosure;

FIG. 8 is a top view of the transfer tray after removing a permanent magnet fixing element according to the second embodiment of the present disclosure.

FIG. 9 is a sectional view of the transfer tray according to the second embodiment of the present disclosure.

### DETAILED DESCRIPTION OF THE DISCLOSURE

In order to alleviate the shake phenomenon of the transfer tray of the transport robot, an embodiment of the present disclosure provides a transfer tray of a transport robot and the transport robot having such a transfer tray.

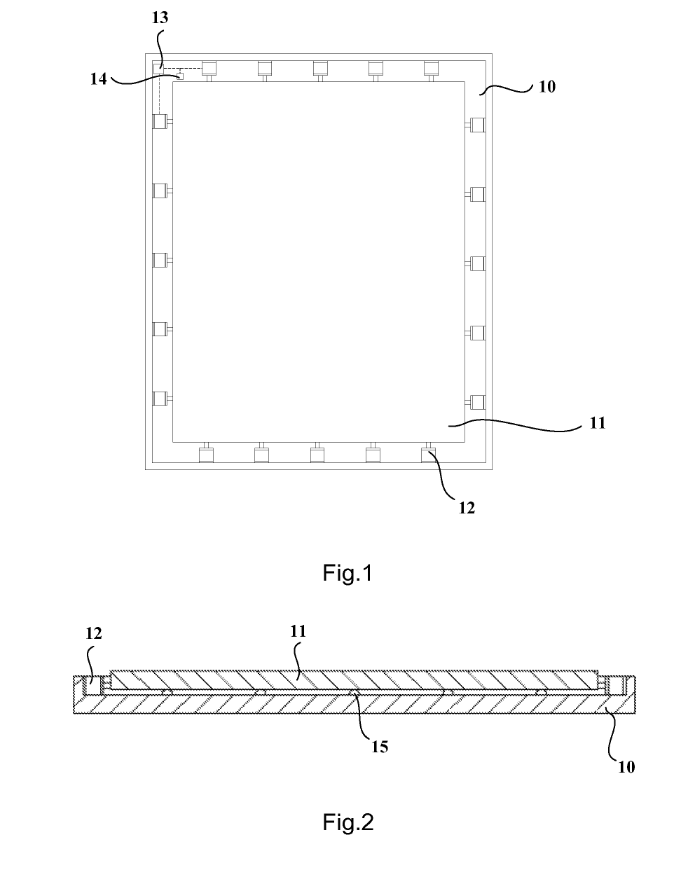

As shown in FIG. 1, the transfer tray of the transport robot according to an embodiment of the present disclosure comprises a fixed tray 10 and a movable tray 11 which is movable relative to the fixed tray 10; several anti-shake actuators 12 disposed on the fixed tray; a shake detection device 14 disposed on the movable tray or the fixed tray; and a control device 13.

The shake detection device 14 is used to detect the shake information of the movable tray or the fixed tray. It should be noted that apart from the position shown in FIG. 1, the shake detection device 14 can also be located at other position.

The control device 13 is electrically connected with the shake detection device 14 and several anti-shake actuators 12, which can control several anti-shake actuators to drive the movable tray to move in a direction opposite to the shaking direction based on the shake information of the movable tray or the fixed tray.

In the above embodiment, the shake information of the movable tray or the fixed tray specifically comprises shaking amplitude or shaking direction of the movable tray or the fixed tray. The shake detection device is not limited to particular kind, for example, it can be a gyroscope or an accelerometer and the like. Besides, the specific install positions of the anti-shake actuators are not limited to the positions shown in the drawing; it can be installed at the upper side or the lower side, or the left side or the right side of the movable tray. In this way, when the transfer tray moves up and down or left and right, the anti-shake actuators can compensate the shake of the transfer tray.

In the embodiment of the present disclosure, when the transfer tray shakes, the anti-shake actuators can drive the movable tray to move in a direction opposite to the shaking direction, thereby to compensate the shake of the transfer tray. In this way, the transfer tray can be stabilized, and the food or liquid on the transfer tray can be avoided spilling out, so the safety of the things when transporting is high.

In a specific embodiment of the present disclosure, the fixed tray 10 has a containing space. The movable tray 11 is disposed in the containing space of the fixed tray and can move horizontally relative to the fixed tray. The several anti-shake actuators 12 are disposed between the side face of the movable tray 11 and the inside wall of the fixed tray 10.

In certain embodiments, the movable tray is a rectangular movable tray, there are anti-shake actuators between the at least two adjacent side faces of the rectangular movable tray and the inside wall of the fixed tray respectively. By means of the design, the anti-shake actuators can apply pulling force or pushing force to the movable tray in a direction opposite to the shaking direction, so as to compensate the shake of the transfer tray.

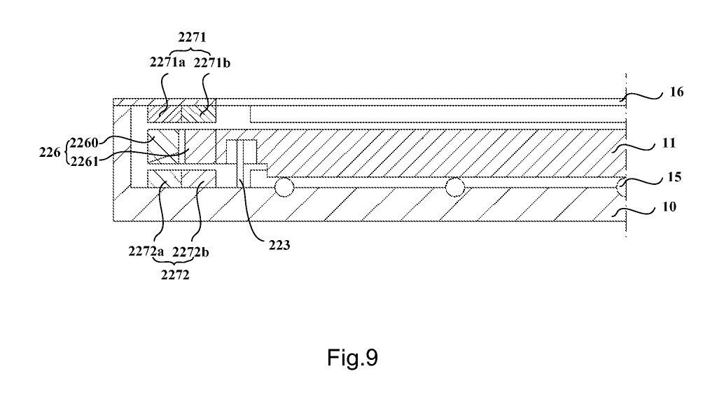

Further in certain embodiments, referring to FIG. 2 and FIG. 9, the bottom of the movable tray is provided with balls 15, or alternatively the inter bottom wall of the fixed tray is provided with balls 15. By this rolling friction design, the friction of the movable tray relative to the fixed tray when moving can be reduced.

The structure type of the anti-shake actuator is not limited to the example shown herein. In the following, two embodiments will be described to illustrate the structure of the anti-shake actuator. However, the structures of the anti-shake actuator are not limited to those. Moreover, all kinds of structures of the anti-shake actuators based on the mechanism or principle of our disclosure are within the protection scope of the present disclosure.

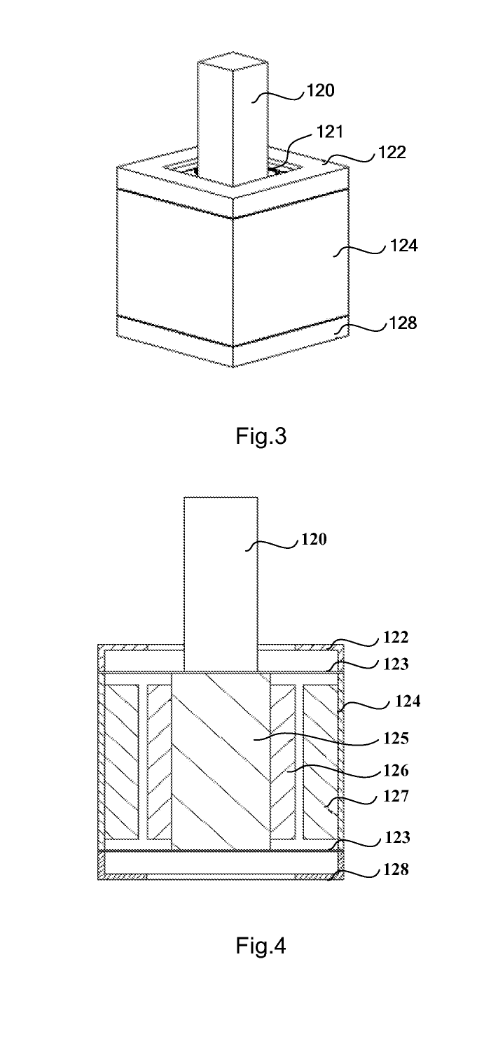

In an embodiment of the present disclosure, as shown in FIG. 3 to FIG. 5, the anti-shake actuator comprises:

a connecting post 120; a housing; and a fixing post 125, a first coil 126, a plurality of first permanent magnets 127 and elastic member(s) 123 disposed in the housing, wherein:

the housing comprises a pedestal 128, a top lid 122 and a yoke 124 located between the pedestal and the top lid, wherein the top lid has a through hole 121 which avoids the first coil and the fixing post, the connecting post 120 is fixedly connected with the fixing post 125 through the through hole 121 of the top lid;

the first coil 126 is placed around the outside of the fixing post 125, the plurality of first permanent magnets 127 are arranged to surround the first coil 126 and the sides facing the first coil 126 have the same magnetic property, the yoke 124 is fixedly connected with the outside of the plurality of the first permanent magnets 127, and the elastic member 123 connects the housing and the fixing post 125.

In this embodiment, the control device is electrically connected with the shake detection device and the anti-shake actuators. When the transfer tray shakes, the control device can send an electrical signal to the anti-shake actuators. At this time, the first coil 126 is energized with current; the sides of the first permanent magnets 127 facing the first coil 126 have the same magnetic property. According to Ampere's rule, the coil 126 is subject to an Ampere force in a direction towards or away from the pedestal, and the direction of the Ampere force is configured to be opposite to the shaking direction of the transfer tray. Under the Ampere force, the anti-shake actuators will drive the movable tray to move in a direction opposite to the shaking direction, so as to compensate the shake of the transfer tray. During this movement, the elastic member 123 will be deformed elastically. Therefore, under the action of the elastic member 123, the anti-shake actuators will restore its original state after the movement; thereby the movable tray will also restore its original state after movement.

Wherein, the type of the fixing post is not limited to the type described herein. It can employ a magnetically conductive fixing post; the type of the elastic member 123 is not limited to type described herein, for example, it can be planar spring. When the elastic member is a planar spring, as shown in FIG. 6, the planar spring comprises an outer coil 1230, an inner coil 1232 and a spring wire 1231 connecting the outer coil and the inner coil, wherein the inner coil 1232 is fixedly connected with the fixing post, and the outer coil 1230 is fixedly connected with the housing 124.

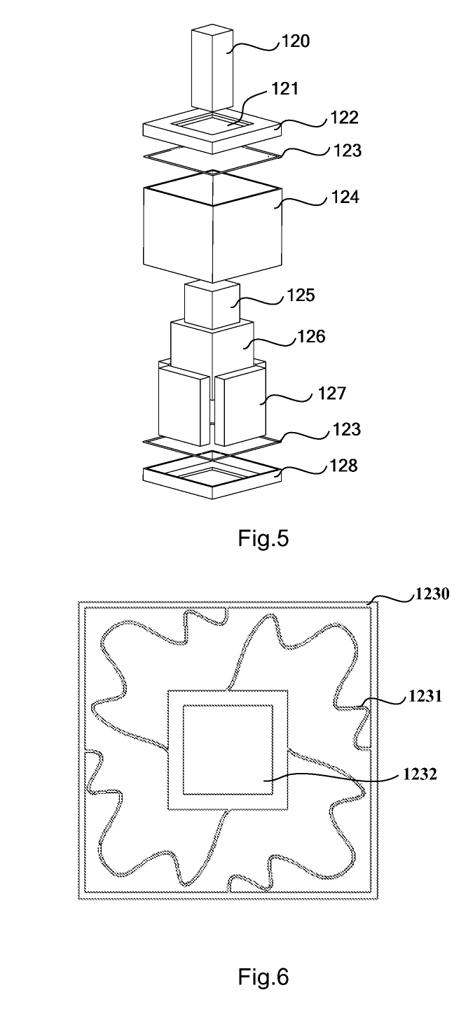

In an optional embodiment, there are two planar springs (as shown in FIG. 5), the outer coil of one of the planar springs is fixedly connected with the top lid, the outer coil of the other planar spring is fixedly connected with the pedestal, and the inner coils of the two planar springs are fixedly connected with the housing 124 respectively.

In a specific embodiment, the first coil is a coil in rectangular ring form, the number of the first permanent magnets is four, the four first permanent magnets are arranged to be adjacent to the four side faces of the first coil respectively.

In an optional embodiment, the connecting post is fixedly connected with the movable tray. In this embodiment, the anti-shake actuators are fixedly connected with the movable tray by the connecting post, which not only can provide a pushing force for the movable tray in a direction opposite to the shaking direction, but also provide a pulling force for the movable tray in a direction opposite to the shaking direction, thereby greatly reducing the shake phenomenon of the transfer tray of the transport robot.

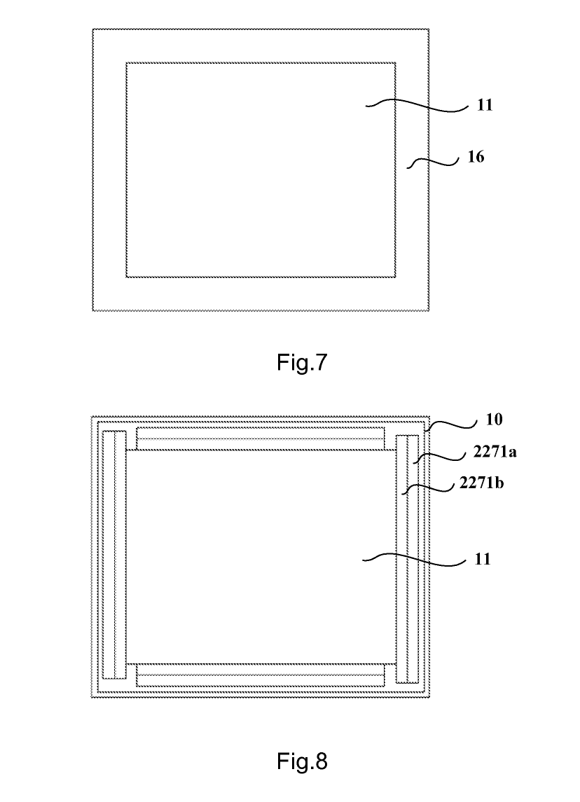

In a second embodiment of the present disclosure, as shown in FIG. 7 to FIG. 9, the transfer tray also comprises a permanent magnet fixing element 16. In an example, the permanent magnet fixing element 16 is located at an edge of the fixed tray of the transfer tray, and is in annular shape.

The anti-shake actuator comprises:

a second coil 226, which is fixedly connected with the movable tray 11;

a first permanent magnet set 2271 and a second permanent magnet set 2272 located at two sides of the second coil and spaced from the second coil. The first permanent magnet set 2271 is fixedly connected with the permanent magnet fixing element 16 and comprises a second permanent magnet 2271a and a third permanent magnet 2271b; the second permanent magnet set 2272 is fixedly connected with the fixed tray 10 and comprises a fourth permanent magnet 2272a and a fifth permanent magnet 2272b located opposite to the second permanent magnet and the third permanent magnet respectively; the magnetic properties of the second permanent magnet 2271a and the third permanent magnet 2271b at the sides facing the second coil are opposite, the magnetic properties of the fourth permanent magnet 2272a and the fifth permanent magnet 2272b at the sides facing the second coil are opposite, and the magnetic properties of the second permanent magnet 2271a and the fourth permanent magnet 2272a at the sides facing the second coil are opposite; and

a return spring 323, one end of which is connected with the fixed tray 10 and the other end of which is connected with the movable tray 11.

In this embodiment, the control device is electrically connected with the shake detection device and the anti-shake actuators. When the transfer tray shakes, the control device can send an electrical signal to the anti-shake actuators. At this time, the second coil is energized with current. The second coil is divided into a first portion 2260 and a second portion 2261 according to the current direction through there (for example, relative to the paper surface). The current directions through the first portion 2260 and the second portion 2261 are opposite, and magnetic field directions through the first portion and the second portion are also opposite. Therefore, according to Ampere's rule, the first portion and the second portion are subject to Ampere force in a same direction. The control device can control the current direction to make the Ampere force have direction opposite to the shaking direction of the transfer tray. Under the Ampere force, the anti-shake actuators will drive the movable tray to move in a direction opposite to the shaking direction, so as to compensate the shake of the transfer tray. During this movement, the return spring will be deformed elastically. Therefore, under the action of the return spring, the anti-shake actuator will restore its original state after the movement; thereby the movable tray will also restore its original state after movement.

The present embodiment also provides a transport robot comprising the transfer tray according to any one of the previous embodiments. The transport robot has the good capability of preventing shaking and has high safety in transporting things.

It will be apparent to those skilled in the art that various modifications and variations can be made to the present disclosure without departing from the spirit or scope of the application. If the modifications and variations are within the spirit and principle of the claims and their appropriate legal equivalents of the application, these modifications and variations are included within the scope of the present application. In the context of the present application, the orientation or position relationship indicated by terms “upper”, “lower”, “inner” and “outer” and the like are orientation or position relationship based on the orientation or position relationship shown in the drawings, which is merely for convenience of description and simplicity, and is not intended to suggest or imply that those devices or elements must have particular orientation, configure or operate in certain orientations, therefore such description should not be construed as limiting the present application. The term “comprising” does not exclude the presence of other elements or steps. The use of the words “a”, “an” preceding elements does not exclude the presence of a plurality of such elements. Moreover, the use of the terms first, second, etc. preceding elements is used to distinguish one element from another without defining the relationship between elements. The mere fact that certain measures are recited in mutually different dependent claims does not indicate that a combination of these measures cannot be used to advantage. Any reference signs in the claims should not be construed as limiting the scope of the claims or the application.

1. A transfer tray comprising: a fixed tray; a movable tray which can move relative to the fixed tray; several anti-shake actuators disposed on the fixed tray; a shake detection device disposed on the movable tray or the fixed tray; and a control device,
wherein the shake detection device is configured to detect shake information of the movable tray or the fixed tray; and
wherein the control device is configured to control the several anti-shake actuators to drive the movable tray to move in a direction opposite to a shaking direction based on the shake information of the movable tray or the fixed tray.

2. The transfer tray according to claim 1, wherein the fixed tray has a containing space, the movable tray is disposed in a containing space of the fixed tray and can move horizontally relative to the fixed tray, and the several anti-shake actuators are disposed between a side face of the movable tray and an inside wall of the fixed tray.

3. The transfer tray according to claim 2, wherein the movable tray is a rectangular movable tray, and anti-shake actuators are located between at least two adjacent side faces of the rectangular movable tray and the inside wall of the fixed tray respectively.

4. The transfer tray according to claim 3, wherein the bottom of the movable tray is provided with balls, or alternatively an inter bottom wall of the fixed tray is provided with balls.

5. The transfer tray according to claim 1, wherein the anti-shake actuator comprises
a connecting post; a housing; and a fixing post, a first coil, a plurality of first permanent magnets and an elastic member disposed in the housing,
wherein the housing comprises a pedestal, a top lid and a yoke located between the pedestal and the top lid, the top lid has a through hole which avoids the first coil and the fixing post, the connecting post is fixedly connected with the fixing post through the through hole of the top lid; and
wherein the first coil is placed around the outside of the fixing post, the plurality of first permanent magnets are arranged to surround the first coil and sides of the plurality of first permanent magnets facing the first coil have a same magnetic property, the yoke is fixedly connected with outsides of the plurality of first permanent magnets, the elastic member connects the housing and the fixing post.

6. The transfer tray according to claim 5, wherein the elastic member is a planar spring, the planar spring comprises an outer coil, an inner coil and a spring wire connecting the outer coil and the inner coil, the inner coil is fixedly connected with the fixing post, and the outer coil is fixedly connected with the housing.

7. The transfer tray according to claim 6, wherein there are two planar springs, one of the planar springs is adjacent to the top lid and has an outer coil connected with the top lid and an inner coil connected with the fixing post, the other of the planar springs is adjacent to the pedestal and has an outer coil connected with the pedestal and an inner coil connected with the fixing post.

8. The transfer tray according to claim 5, wherein the first coil is a coil in rectangular ring form, the number of the first permanent magnets is four, and wherein the four first permanent magnets are arranged to be adjacent to four side faces of the first coil.

9. The transfer tray according to claim 5, wherein the connecting post is fixedly connected with the movable tray.

10. The transfer tray according to claim 5, wherein, the fixing post is a magnetically conductive fixing post.

11. The transfer tray according to of claim 1, wherein the transfer tray further comprises a permanent magnet fixing element, and the anti-shake actuator comprises:
a second coil, which is fixedly connected with the movable tray;
a first permanent magnet set and a second permanent magnet set located at two sides of the second coil and spaced from the second coil, wherein the first permanent magnet set is fixedly connected with the permanent magnet fixing element, and the second permanent magnet set is fixedly connected with the fixed tray;
a return spring, one end of which is connected with a fixed tray and the other end is connected with the movable tray.

12. The transfer tray according to claim 11, wherein the first permanent magnet set comprises a second permanent magnet and a third permanent magnet, and the second permanent magnet set comprises a fourth permanent magnet and a fifth permanent magnet located opposite to the second permanent magnet and a third permanent magnet, the magnetic properties of the second permanent magnet and the third permanent magnet at sides facing the second coil are opposite, the magnetic properties of the fourth permanent magnet and the fifth permanent magnet at sides facing the second coil are opposite, the magnetic properties of the second permanent magnet and the fourth permanent magnet at sides facing the second coil are opposite.

13. The transfer tray according to claim 1, wherein the shake detection device comprises a gyroscope or an accelerometer.

14. A transport robot, comprising the transfer tray according to claim 1.

15. The transfer tray according to claim 2, wherein the anti-shake actuator comprises
a connecting post; a housing; and a fixing post, a first coil, a plurality of first permanent magnets and an elastic member disposed in the housing,
wherein the housing comprises a pedestal, a top lid and a yoke located between the pedestal and the top lid, the top lid has a through hole which avoids the first coil and the fixing post, the connecting post is fixedly connected with the fixing post through the through hole of the top lid; and
wherein the first coil is placed around the outside of the fixing post, the plurality of first permanent magnets are arranged to surround the first coil and sides of the plurality of first permanent magnets facing the first coil have a same magnetic property, the yoke is fixedly connected with outsides of the plurality of first permanent magnets, the elastic member connects the housing and the fixing post.

16. The transfer tray according to claim 3, wherein the anti-shake actuator comprises
a connecting post; a housing; and a fixing post, a first coil, a plurality of first permanent magnets and an elastic member disposed in the housing,
wherein the housing comprises a pedestal, a top lid and a yoke located between the pedestal and the top lid, the top lid has a through hole which avoids the first coil and the fixing post, the connecting post is fixedly connected with the fixing post through the through hole of the top lid; and
wherein the first coil is placed around the outside of the fixing post, the plurality of first permanent magnets are arranged to surround the first coil and sides of the plurality of first permanent magnets facing the first coil have a same magnetic property, the yoke is fixedly connected with outsides of the plurality of first permanent magnets, the elastic member connects the housing and the fixing post.

17. The transfer tray according to claim 4, wherein the anti-shake actuator comprises
a connecting post; a housing; and a fixing post, a first coil, a plurality of first permanent magnets and an elastic member disposed in the housing,
wherein the housing comprises a pedestal, a top lid and a yoke located between the pedestal and the top lid, the top lid has a through hole which avoids the first coil and the fixing post, the connecting post is fixedly connected with the fixing post through the through hole of the top lid; and
wherein the first coil is placed around the outside of the fixing post, the plurality of first permanent magnets are arranged to surround the first coil and sides of the plurality of first permanent magnets facing the first coil have a same magnetic property, the yoke is fixedly connected with outsides of the plurality of first permanent magnets, the elastic member connects the housing and the fixing post.

18. The transfer tray according to claim 2, wherein the transfer tray further comprises a permanent magnet fixing element, the anti-shake actuator comprises
a second coil, which is fixedly connected with the movable tray;
a first permanent magnet set and a second permanent magnet set located at two sides of the second coil and spaced from the second coil, wherein the first permanent magnet set is fixedly connected with the permanent magnet fixing element, and the second permanent magnet set is fixedly connected with the fixed tray;
a return spring, one end of which is connected with a fixed tray and the other end is connected with the movable tray.

19. The transfer tray according to claim 3, wherein the transfer tray further comprises a permanent magnet fixing element, the anti-shake actuator comprises
a second coil, which is fixedly connected with the movable tray;
a first permanent magnet set and a second permanent magnet set located at two sides of the second coil and spaced from the second coil, wherein the first permanent magnet set is fixedly connected with the permanent magnet fixing element, and the second permanent magnet set is fixedly connected with the fixed tray;
a return spring, one end of which is connected with a fixed tray and the other end is connected with the movable tray.

20. The transfer tray according to claim 4, wherein the transfer tray further comprises a permanent magnet fixing element, the anti-shake actuator comprises
a second coil, which is fixedly connected with the movable tray;
a first permanent magnet set and a second permanent magnet set located at two sides of the second coil and spaced from the second coil, wherein the first permanent magnet set is fixedly connected with the permanent magnet fixing element, and the second permanent magnet set is fixedly connected with the fixed tray;
a return spring, one end of which is connected with a fixed tray and the other end is connected with the movable tray.
